(19) United States
(12) Patent Application Publication
(10) Pub. No.: US 2015/0096493 A1
(43) Pub. Date: Apr. 9, 2015

(54) SPRAY COATER

(71) Applicant: LEAP Co., Ltd., Yokohama-shi (JP)

(72) Inventors: Tokinori TERADA, Yokohama-shi (JP); Takashi SANO, Yokohama-shi (JP)

(73) Assignee: LEAP Co., Ltd., Yokohama-shi (JP)

(21) Appl. No.: 14/048,896

(22) Filed: Oct. 8, 2013

(51) Int. Cl. B05C 5/02

(52) U.S. Cl. CPC B05C 5/02
USPC 118/642; 118/66

(57) ABSTRACT

A spray coater having a nozzle for spraying a coating liquid, a heater, a slider mounting the nozzle and the heater, and capable of moving reciprocatorily in perpendicular two directions, and a substrate holder holding a substrate so that the surface faces downward with respect to the nozzle, the spray coater forming a thick film by spraying and applying the coating liquid to the surface of the substrate by the nozzle and then heating and drying the coating liquid by the heater, wherein an application of the coating liquid is carried out sequentially by a spray area, and the nozzle and the heater are arranged in parallel so that the drying to the spray area to which the application has been performed is carried out immediately after the application, thereby forming a flat thick film even on a large-sized substrate.

### BACKGROUND

The presently disclosed embodiment relates to a spray coater for applying a coating liquid to a substrate, and more particularly to a spray coater for forming a flat coating film or a flat multi-layer film, having arbitrary film thickness, on a large-sized substrate.

Recently, as seen in growing size of a display substrate such as a display panel, there is a need for a spray coater capable of freely selecting and coating a thick film or a multi-layer film and the like to an uneven substrate surface of a large-sized substrate of 1-3 m2 or more. The conventional spray coater has employed a method for forming a thick film by rotating the substrate attached to the substrate holder. However, it is difficult to rotate or move such a large-sized substrate at the predetermined speed while being held by the substrate holder, and thus, there has been a problem to form a flat thick film.

FIGS. 5a, 5b and 5c are a comparison diagram between coating films formed by the spray coater of the presently disclosed embodiment and the conventional spray coater. FIG. 5a shows a coating film formed by the conventional spray coater. In regard to the large-sized substrate, it is difficult to control the wettability of the convex-concave shaped surface of the substrate to be uniform, and therefore, the surface of the thick film 97 becomes uneven, and in some cases, an uncoated part may occur.

The patent document 1 Japan Unexamined Patent Publication No. 2000-140745 discloses a method having: an film adhesion process where a coating liquid to be a coating film is sprayed on the surface of a substrate on which the coating film is formed, and the coating liquid is adhered on the surface; and a film formation process where the substrate is axially rotated along the central axis of the surface, in order to form the coating film comprized of the coating liquid on the surface.

### SUMMARY

The purpose of the presently disclosed embodiment is to provide a spray coater for forming a flat coating film or a multi-layer film, having arbitrary film thickness, on the surface of the large-sized substrate.

The spray coater of the presently disclosed embodiment is a spray coater where a spray nozzle for spraying a coating liquid and a heater are mounted on a slider which is capable of moving reciprocatorily in two directions perpendicular to each other, and a substrate fixed and held by a substrate holder is disposed so that a surface of the substrate faces downward with respect to the spray nozzle, the spray coater being adapted to form a thick film by spraying the coating liquid by the spray nozzle so as to apply the coating liquid to the surface of the substrate and then heating and drying the coating liquid by the heater, wherein an application of the coating liquid by spraying from the spray nozzle is carried out sequentially by a spray area, and the spray nozzle and the heater are arranged in parallel and mounted on the slider so that the drying by the heater to the spray area to which the application has been performed is carried out immediately after the application.

The nozzle portion of the spray coater of the presently disclosed embodiment is characterized in that a multistage inert chamber is attached to the spray nozzle, the multistage inert chamber defining the spray area as well as adjustably setting a distance from the substrate.

The spray nozzle of the spray coater of the presently disclosed embodiment is composed of: a solute spray nozzle for spraying a solute of the coating liquid; and solvent spray nozzles for spraying a solvent of the coating liquid, the solvent spray nozzles being disposed so as to surround the solute spray nozzle in the center.

The spray nozzle of the spray coater of the presently disclosed embodiment is driven so that the spraying of the solute by the solute spray nozzle and the spraying of the solvent by the solvent spray nozzles are alternately carried out with predetermined numbers of times.

The spray coater of the presently disclosed embodiment is characterized in that the spray nozzle is mounted on the slider so as to be rotatable with respect to a spray axis.

The heater of the spray coater of the presently disclosed embodiment is a spot type heater comprising a lamp light source, and includes a light guide which guides a light from the lamp light source toward a coated surface of the substrate.

The heater of the spray coater of the presently disclosed embodiment is a ring type heater comprising a plurality of lamp light sources disposed so as to surround a circumference of the multistage inert chamber, and includes a light guide which guides a light from the lamp light sources toward a coated surface of the substrate.

The spray coater of the presently disclosed embodiment is characterized in that a clogging prevention box which carries out a purge before initiating the spraying of the coating liquid by the spray nozzle and a cleaning of the spray nozzle after completing the spraying is further provided.

The presently disclosed embodiment can provide a spray coater for forming a flat coating film or a flat multi-layer film, having arbitrary film thickness, on the surface of the large-sized substrate.

### BRIEF DESCRIPTION OF THE DRAWINGS

FIG. 1 is a configuration diagram of the spray coater according to the first embodiment of the presently disclosed embodiment.

FIG. 2 is a configuration diagram of the spray nozzle of the presently disclosed embodiment.

FIG. 3 is a structural diagram of the chamber surrounding the spray nozzle of the presently disclosed embodiment.

FIGS. 4a and 4b are a configuration diagram of the spray coater according to the second embodiment of the presently disclosed embodiment.

FIGS. 5a, 5b and 5c are a comparison diagram between the coating films formed by the spray coater of the presently disclosed embodiment and the conventional spray coater.

### DESCRIPTION OF NUMERICAL REFERENCES

10: nozzle portion
12: solute spray nozzle
14: solvent spray nozzle
16: multistage inert chamber
17: adjuster portion
20: substrate holder
30: lamp portion
35: lamp
37: light guiding plate
40: slider
50: rail
60: substrate
70: clogging prevention box
95: substrate with bumps
97: coating film
100: spray coater according to the first easpect of the presently disclosed embodiment
200: spray coater according to the second aspect of the presently disclosed embodiment

### DETAILED DESCRIPTION

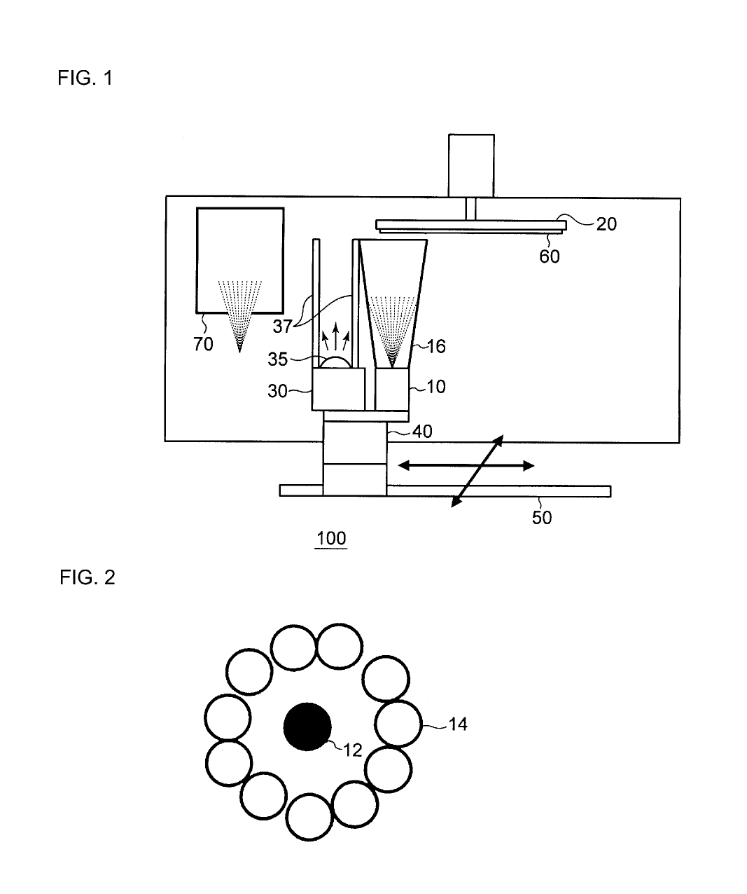

Referring to the drawings, the aspects of the presently disclosed embodiment are hereinafter explained. FIG. 1 is a configuration diagram of the spray coater according to the first aspect of the presently disclosed embodiment. Referring to FIG. 1, the spray coater 100 according to the first embodiment comprises: a rail 50; a slider 40 adapted to move back and forth reciprocatorily on the rail 50 while the top part of the slider moves right and left reciprocatorily; a nozzle portion 10 comprising a spray nozzle; and a lamp portion 30 comprising a lamp 35 which functions as a heater and heats the substrate 60. The nozzle portion and the lamp portion are arranged in parallel on the slider 40.

The lamp portion 30 includes a cylindrical light guiding plate 37 which adjusts the light of the lamp 35 in the direction of the substrate 60. The substrate 60 is disposed so that the surface of the substrate, which is fixed and held by a substrate holder 20, faces downward with respect to the spray nozzle. Furthermore, above the nozzle portion 10 and the lamp portion 30, the substrate holder 20 which holds the substrate 60, and a clogging prevention box 70 which carries out a purge before initiating the spraying of the coating liquid by the spray nozzle and a cleaning of the spray nozzle after completing the spraying are provided.

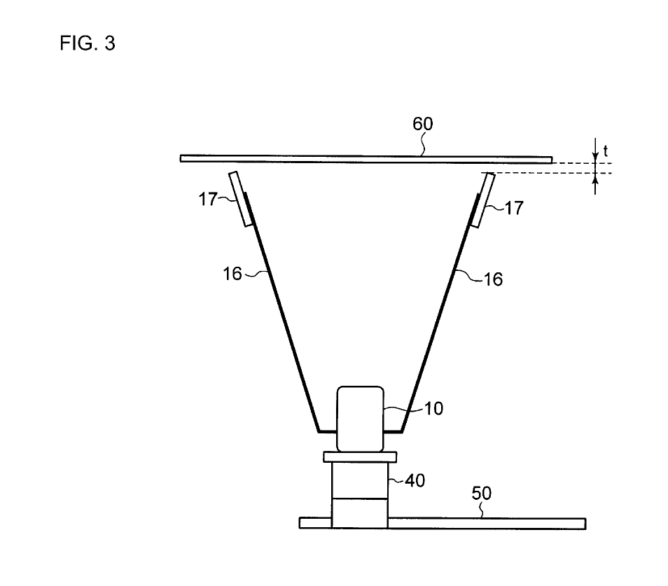

FIG. 2 is a configuration diagram of the spray nozzle of the presently disclosed embodiment. Referring to FIG. 2, the spray nozzle provided in the nozzle portion 10 has the configuration where solvent spray nozzles 14 are disposed so as to surround a solute spray nozzle 12 in the center. FIG. 3 is a structural diagram of the chamber surrounding the spray nozzle of the presently disclosed embodiment. Referring to FIG. 3, a multistage inert chamber 16 is attached to the nozzle portion 10. This chamber 16 defines a spray area in the spray nozzle, and also includes an adjuster portion 17 which adjustably sets the distance t between the surface of the substrate 60 and the top of the adjuster portion.

Next, based on FIGS. 1 to 3, the formation of the thick film is explained. Referring to FIG. 1, the substrate 60 is attached to the substrate holder 20, and also the adjuster portion 17 of the chamber 16 surrounding the nozzle portion 10 is set at the predetermined distance t from the surface of the substrate 60, and then the coating operation is initiated. At this point, the slider 40 is suspended at the portion where the nozzle portion 10 is stopped just beneath of the clogging prevention box 70. From the solvent spray nozzles 14 and the solute spray nozzle 12 of the nozzle portion 10, the solvent and the solute are purged respectively toward the clogging prevention box 70, thereby setting the initial state of the each nozzle.

Then, the slider 40 starts the motion in which the top portion thereof moves right and left reciprocatorily while the slider moves back and forth reciprocatorily on the rail 50. The solute from the solute spray nozzle 12 of the nozzle portion 10 at first, and then the solvent from the solvent spray nozzle 14 are sprayed alternately and repeatedly toward the surface of the substrate 60 to be coated. This application of the coating liquid by the spraying from the spray nozzle is carried out sequentially by a spray area which is formed by the chamber 16. From the lamp portion 30 which is mounted and arranged in parallel with the spray nozzle portion 10, to the spray area to which the application has just been performed, the drying by the lamp 35 is carried out immediately after the application.

As such, the chamber 16 creates the spray area unit which is made of the space in the high efficient inert state adapted to the property of the coating material by adjusting the adjuster portion 17, thereby allowing the property of the coating material to be safely extracted. Also, the evaporation of the solvent is inhibited by disposing the solute spray nozzle 12 around the solvent spray nozzle 14 and spraying from them alternately and repeatedly, thereby forming the uniform coating film.

Furthermore, since the drying is immediately carried out to the spray area to which the application has just been performed, the more uniform coating film is able to be formed on the coated surface.

Since the lamp portion 30 includes the cylindrical light guiding plate 37 adjusting the light of the lamp 35 toward the substrate 60 direction, it can emit the light of uniform intensity to the desired range, as well as preventing the illumination of the light to the solute and the solvent being sprayed, thereby preventing the reduction of adhesion of the coating film. Furthermore, each nozzle may be rotated about the spraying axis, thereby resolving the uneven spraying due to the flaw etc. of the spraying outlet of the nozzle.

As explained above, the slider 40 reciprocatorily moves on the rail 50 in two directions perpendicular to each other, and the thick film is formed on the predetermined surface or the entire surface of the substrate 60. When the operation is completed, the slider 40 returns to and stops at the position where the nozzle portion 10 is stopped just beneath of the clogging prevention box 70, and the cleaning is carried out to each nozzle for preventing the clogging thereof.

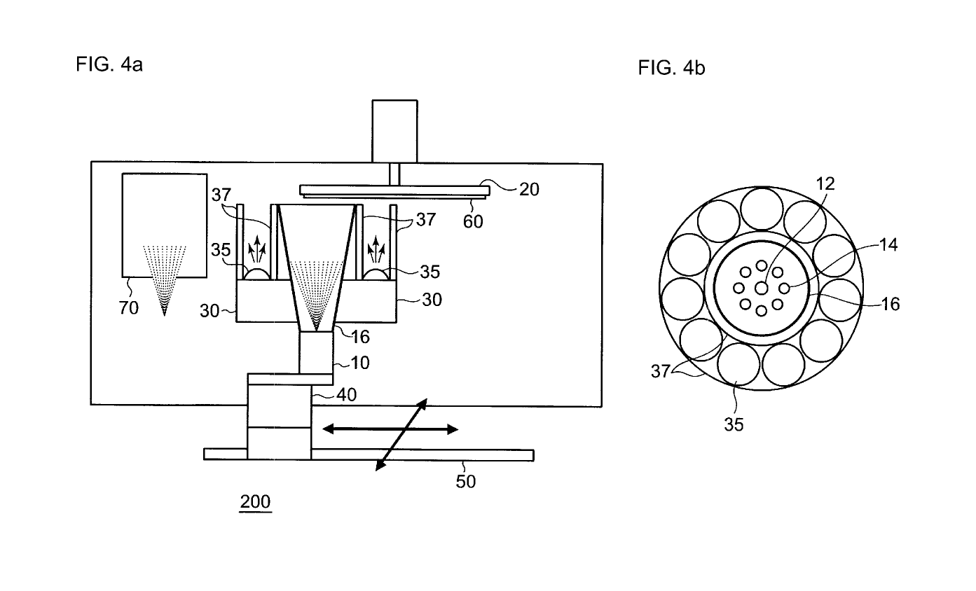

FIGS. 4a and 4b are a configuration diagram of the spray coater according to the second aspect of the presently disclosed embodiment. Referring to FIG. 4a, the light guiding plate 37 attached to the lamp portion 30 of the spray coater 200 according to the second aspect is configured to further surround the chamber 16 which surrounds the entire nozzle portion 10. Referring to FIG. 4b, two light guiding plates 37 are configured to surround the chamber 16, and they have a plurality of lamps 35 inside thereof. Although the thick film forming process according to the second embodiment is the same as the forming process according to the first aspect, the plurality of lamps 35 surrounding the nozzle portion 10 allows the effect of drying the thick film to be further improved.

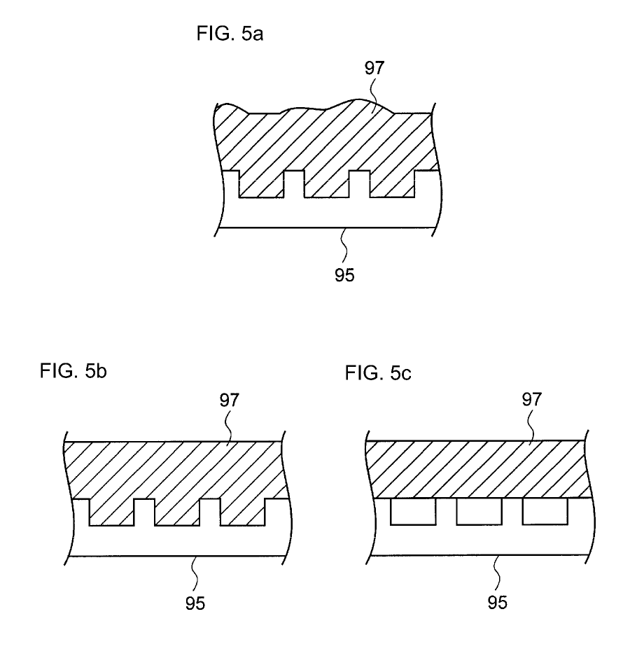

FIG. 5b shows the coating film formed by spraying the solute and the solvent from beneath of the substrate having bumps in the spray coaters 100 and 200 according to the first and the second aspects respectively as set forth above. The surface of the coating film 97 is not be affected by any influence of the concave-convex shape and wettability of the surface of the substrate, but is formed as the flat thick film having the uniform surface. Also shown in FIG. 5c, the coating film 97 may be formed only on the convex portions without the solvent and the solute being flowed into the concave potions by regulating the concentrations of the solvent and the solute. Accordingly, both of the spray coaters 100 and 200 are able to form the coating film having the desired film thickness on the entire surface or the desired location of the substrate. Furthermore, any arbitrary multi-layer film may be formed by spraying different solutes and solvents from the plurality of the nozzles.

As explained above, the presently disclosed embodiment can provide a spray coater for forming a flat coating film or a flat multi-layer film, having arbitrary film thickness, on the surface of the large-sized substrate.

What is claimed is:

1. A spray coater where a spray nozzle for spraying a coating liquid and a heater are mounted on a slider which is capable of moving reciprocatorily in two directions perpendicular to each other, and a substrate fixed and held by a substrate holder is disposed so that a surface of the substrate faces downward with respect to the spray nozzle, the spray coater being adapted to form a thick film by spraying the coating liquid by the spray nozzle so as to apply the coating liquid to the surface of the substrate and then heating and drying the coating liquid by the heater, wherein
an application of the coating liquid by spraying from the spray nozzle is carried out sequentially by a spray area, and the spray nozzle and the heater are arranged in parallel and mounted on the slider so that the drying by the heater to the spray area to which the application has been performed is carried out immediately after the application.

2. The spray coater according to claim 1, wherein a multistage inert chamber is attached to the spray nozzle, the multistage inert chamber defining the spray area as well as adjustably setting a distance from the substrate.

3. The spray coater according to claim 1, wherein the spray nozzle is composed of: a solute spray nozzle for spraying a solute of the coating liquid; and solvent spray nozzles for spraying a solvent of the coating liquid, the solvent spray nozzles being disposed so as to surround the solute spray nozzle in the center.

4. The spray coater according to claim 3, wherein the spray nozzle is driven so that the spraying of the solute by the solute spray nozzle and the spraying of the solvent by the solvent spray nozzles are alternately carried out with predetermined numbers of times.

5. The spray coater according to claim 1, wherein the spray nozzle is mounted on the slider so as to be rotatable with respect to a spray axis.

6. The spray coater according to claim 1, wherein the heater is a spot type heater comprising a lamp light source, and includes a light guide which guides a light from the lamp light source toward a coated surface of the substrate.

7. The spray coater according to claim 2, wherein the heater is a ring type heater comprising a plurality of lamp light sources disposed so as to surround a circumference of the multistage inert chamber, and includes a light guide which guides a light from the lamp light sources toward a coated surface of the substrate.

8. The spray coater according to claim 1, wherein a clogging prevention box which carries out a purge before initiating the spraying of the coating liquid by the spray nozzle and a cleaning of the spray nozzle after completing the spraying is further provided.
